(19) United States
(12) Patent Application Publication
(10) Pub. No.: US 2017/0213615 A1
(43) Pub. Date: Jul. 27, 2017

(54) METAL NANOPARTICLE DISPERSION AND METAL COATING FILM

(71) Applicant: SUMITOMO ELECTRIC INDUSTRIES, LTD., Osaka-shi, Osaka (JP)

(72) Inventors: Issei OKADA, Osaka (JP); Motohiko SUGIURA, Osaka (JP)

(73) Assignee: SUMITOMO ELECTRIC INDUSTRIES, LTD., Osaka-shi, Osaka (JP)

(21) Appl. No.: 15/326,719

(22) PCT Filed: Jul. 10, 2015
(86) PCT No.: PCT/JP2015/069901

§ 371 Date: Jan. 17, 2017

(30) Foreign Application Priority Data
Jul. 22, 2014 (JP) 2014-148689

(51) Int. Cl. H01B 1/22; B22F 3/10; H01B 13/00; B22F 5/00; H01B 1/02; B22F 1/00; B22F 9/24

(52) U.S. Cl. CPC H01B 1/22; B22F 1/0022; B22F 3/1021; B22F 9/24; B22F 5/006; H01B 1/026; H01B 13/0036; B22F 2009/245; B22F 2301/10; B22F 2304/056; B22F 2998/10

(57) ABSTRACT

A metal nanoparticle dispersion for forming a metal coating film by application and sintering contains metal nanoparticles having an average particle size of 200 nm or less and a solvent used to disperse the metal nanoparticles. The metal nanoparticle dispersion further contains a water soluble resin. The amount of the water soluble resin contained is preferably 0.1 parts by mass or more and 10 parts by mass or less per 100 parts by mass of the metal nanoparticles.

### TECHNICAL FIELD

The present invention relates to a metal nanoparticle dispersion and a metal coating film.

### BACKGROUND ART

In recent years, a particular method for forming a metal coating film on a surface of a substrate has been increasingly adopted in producing printed circuit board and the like. This method involves applying a metal nanoparticle dispersion containing a solvent and nanosized fine metal particles dispersed therein to a surface of a substrate to form a coating film, and heating the coating film to dry and sinter the coating film into a metal coating film.

There has been a proposal of a metal nanoparticle dispersion used for forming such a metal coating film. According to this proposal, the metal nanoparticle dispersion is prepared by mixing silver or silver oxide ultrafine particles having a particle size of 0.001 to 0.1 μm with an organic solvent that does not easily evaporate at room temperature but does evaporate during drying and sintering, and has a room temperature viscosity of 1000 cP or less (refer to PTL 1).

### CITATION LIST

### Patent Literature

PTL 1: Japanese Unexamined Patent Application Publication No. 2001-35814

### SUMMARY OF INVENTION

### Technical Problem

A metal coating film formed by applying and sintering a metal nanoparticle dispersion such as one disclosed in PTL 1 tends to have small cracks in all parts due to a volume loss of the coating film of the metal nanoparticle dispersion during sintering.

Such a cracked metal coating film occasionally makes it difficult to uniformly form another layer of a different material thereon or to separate from the substrate.

Under the circumstances described above, an object is to provide a metal nanoparticle dispersion capable of forming a metal coating film with less cracks, and a metal coating film with less crack.

### Solution to Problem

A metal nanoparticle dispersion according to one aspect of the present invention aimed to solve the problem described above is a metal nanoparticle dispersion for forming a metal coating film by application and sintering, the metal nanoparticle dispersion containing metal nanoparticles having an average particle size of 200 nm or less and a solvent used to disperse the metal nanoparticles, in which the metal nanoparticle dispersion further contains a water soluble resin.

### Advantageous Effects of Invention

A metal coating film with less crack can be formed by using the metal nanoparticle dispersion according to one aspect of the present invention.

### BRIEF DESCRIPTION OF DRAWING

FIG. 1 is a flowchart showing a method for producing a metal coating film according to an embodiment of the present invention.

### DESCRIPTION OF EMBODIMENTS

### Description of Embodiments of the Present Invention

A metal nanoparticle dispersion according to one embodiment of the present invention is a metal nanoparticle dispersion for forming a metal coating film by application and sintering, the metal nanoparticle dispersion containing metal nanoparticles having average particle size of 200 nm or less and a solvent used to disperse the metal nanoparticles, in which the metal nanoparticle dispersion further contains a water soluble resin. In other words, the metal nanoparticle dispersion according to one embodiment of the present invention is a metal nanoparticle dispersion for forming a metal coating film by application and sintering, the metal nanoparticle dispersion containing metal nanoparticles having average particle size of 200 nm or less and a solvent used to disperse the metal nanoparticles (a metal coating film is formed by applying the metal nanoparticle dispersion and sintering the applied metal nanoparticle dispersion), in which the metal nanoparticle dispersion further contains a water soluble resin.

Since the metal nanoparticle dispersion contains a water soluble resin in addition to the metal nanoparticles and the solvent, shrinking of the coating film is moderated due to the water soluble resin during the process of drying the coating film of the metal nanoparticle dispersion (evaporation of the solvent). Because the water soluble resin is gradually pyrolyzed during sintering of the metal nanoparticles following the drying of the coating film, sintering progresses slowly. Thus, cracking of the metal coating film can be inhibited. When the metal nanoparticle dispersion is used, a metal coating film with less crack on which another material can be easily stacked can be formed and, in particular, a metal coating film with good platability can be formed.

The water soluble resin content is preferably 0.1 or more and 10 or less parts by mass per 100 parts by mass of the metal nanoparticles. When the water soluble resin content is within this range, cracking can be effectively inhibited and, because the water soluble resin is pyrolyzed during sintering, organic residues rarely remain in the metal coating film after sintering.

The number-average molecular weight of the water soluble resin is preferably 1,000 or more and 1,000,000 or less. When the number-average molecular weight of the water soluble resin is within this range, cracking of the coating film can be inhibited, and, because the water soluble resin is pyrolyzed during sintering, organic residues rarely remain in the metal coating film after sintering.

The water soluble resin is preferably any one or combination of polyvinyl alcohol, polyethylene glycol, and polyethyleneimine. When the water soluble resin is any one or combination of polyvinyl alcohol, polyethylene glycol, and polyethyleneimine, not only cracking can be more effectively prevented but also the water soluble resin is easily pyrolyzed by sintering and less organic residues remain in the metal coating film after sintering.

The metal nanoparticles are preferably made of copper. When copper is used as the metal nanoparticles, a metal coating film with a low electrical resistance can be formed and a metal coating film can be offered at a low cost.

A metal coating film according to another embodiment of the present invention is formed by applying the metal nanoparticle dispersion and sintering the applied metal nanoparticle dispersion.

The metal coating film has less crack and larger adhesion to the substrate since it is formed by applying the metal nanoparticle dispersion and sintering the applied metal nanoparticle dispersion.

The “average particle size” refers to a volume median diameter D50 determined by counting 100 or more particles in an image taken with a scanning electron microscope.

The “number-average molecular weight” is a value measured by gel filtration chromatography.

### Details of the Embodiments of the Present Invention

A method for producing a metal coating film according to an embodiment of the present invention will now be described in detail with reference to the drawing.

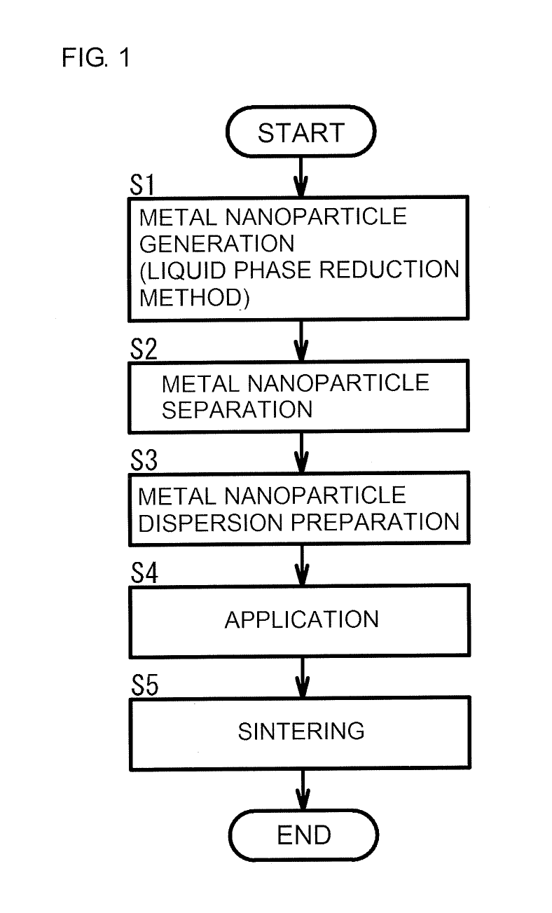

FIG. 1 shows the steps of the method for producing a metal coating film according to an embodiment of the present invention. This method for producing a metal coating film includes a step of generating metal nanoparticles by a liquid phase reduction method (step S1), a step of separating the generated metal nanoparticles (step S2), a step of preparing a metal nanoparticle dispersion by using the separated metal nanoparticles (step S3), a step of applying the resulting metal nanoparticle dispersion to a surface of a substrate (step S4), and a step of forming a metal coating film by sintering a coating film of the metal nanoparticle dispersion (step S5).

### <Metal Nanoparticle Generation Step>

The metal nanoparticle generation step S1 is carried out by a liquid phase reduction method by which metal nanoparticles are precipitated by reducing a metal ion in an aqueous solution containing a reductant. For example, a titanium redox method can be adopted as such a liquid phase reduction method.

Examples of the metal that constitutes metal nanoparticles include copper, nickel, gold, and silver. Among these, copper is preferable for its good electrical conductivity and a relatively low cost.

The metal nanoparticle generation step S1 includes a step of preparing an aqueous solution of a reductant (a reductant aqueous solution preparation step) and a step of precipitating metal nanoparticles by reduction of a metal ion (metal nanoparticle precipitation step). In the metal nanoparticle precipitation step, an aqueous solution containing a metal ion or a water soluble metal compound that generates a metal ion by ionization is added to a reductant aqueous solution so as to reduce the metal ion and precipitate metal nanoparticles.

### [Reductant Aqueous Solution Preparation Step]

In the reductant aqueous solution preparation step, an aqueous solution containing a reductant that has a metal ion reduction action is prepared.

### (Reductant)

Any of various reductants capable of precipitating metal nanoparticles by reducing ions of metal elements in a liquid-phase reaction system can be used as the reductant. Examples of the reductant include sodium borohydride, sodium hypophosphite, hydrazine, and ions of transition metal elements (trivalent titanium ion, divalent cobalt ion, etc.). In order to decrease as much as possible the particle size of the metal nanoparticles to be precipitated, it is effective to decrease the rate of reducing the ions of metal elements and decrease the rate of precipitating metal nanoparticles. In order to decrease the reducing rate and the precipitation rate, a reductant that has reducing power as low as possible is preferably selected and used.

When a titanium redox method is employed as the liquid phase reduction method, a trivalent titanium ion is used as the reductant. The trivalent titanium ion is obtained by dissolving a water soluble titanium compound capable of generating a trivalent titanium ion in water or by reducing an aqueous solution containing a tetravalent titanium ion through cathode electrolysis. An example of the water soluble titanium compound capable of generating a trivalent titanium ion is titanium trichloride. A commercially available, high-concentration aqueous solution of titanium trichloride can be used as this titanium trichloride.

The reductant aqueous solution may further contain a complexing agent, a dispersant, a pH adjustor, etc.

Various complexing agents known in the art can be used as the complexing agent added to the reductant aqueous solution. In order to produce metal nanoparticles that have particle size as small as possible and a particle size distribution as sharp as possible (particle size distribution as narrow as possible), it is effective to shorten as much as possible the length of time taken for the reduction reaction in reducing and precipitating the ion of the metal element by oxidation of the trivalent titanium ion. In order to achieve this, it is effective to control both the oxidation reaction rate of the trivalent titanium ion and the reduction reaction rate of the metal element ion; in order to do so, it is important to form complexes of both the trivalent titanium ion and the metal element ion. Moreover, in order to shorten the time taken for the reduction reaction as much as possible while adjusting the metal element ion reduction rate and the metal nanoparticle precipitation rate at appropriate rates, it is important to adjust the ion concentration and the like.

Examples of the complexing agent that has such a function include trisodium citrate (Na₃C₆H₅O₇), sodium tartrate (Na₂C₄H₄O₆), sodium acetate (NaCH₃CO₂), gluconic acid (C₆H₂O₇), sodium thiosulfate (Na₂S₂O₃), ammonia (NH₃), and ethylenediamine tetraacetate (C₁₀H₆N₂O₈). Any one or combination of these can be used. Among these, trisodium citrate is preferable.

Dispersants with various structures, such as anionic dispersants, cationic dispersants, and nonionic dispersants, can be used as the dispersant to be added to the reductant aqueous solution. Among these, cationic dispersants are preferable and cationic dispersants having a polyethyleneimine structure are more preferable.

Examples of the pH adjustor to be added to the reductant aqueous solution include sodium carbonate, ammonia, and sodium hydroxide. The pH of the reductant aqueous solution may be, for example, 5 or more and 13 or less. When the pH of the reductant aqueous solution is low, the precipitation rate of the metal nanoparticles is decreased and the particle size of the metal nanoparticles is decreased. At an excessively low precipitation rate, the particle size distribution becomes wide. Thus, the pH is preferably adjusted so as not to excessively decrease the precipitation rate. When the pH of the reductant aqueous solution is excessively high, the precipitation rate of the metal nanoparticles is excessively increased and the precipitated metal nanoparticles may agglomerate to form clusters or chains of coarse particles.

### [Metal Nanoparticle Precipitation Step]

In the metal nanoparticle precipitation step, a metal ion is added to the reductant aqueous solution to cause precipitation of metal nanoparticles through reduction of the metal ion with the reductant in the reductant aqueous solution.

### (Metal Ion)

A metal ion is formed as a result of ionization of a water soluble metal compound as the water soluble metal compound is dissolved in water. Examples of the water soluble metal compound include various water soluble compounds such as sulfate compounds, nitrate compounds, acetate compounds, and chlorides.

Specific examples of the water soluble metal compounds include copper compounds such as copper(II) nitrate (Cu(NO₃)₂), copper(II) nitrate trihydrate (Cu(NO₃)₂.3H₂O), copper(II) sulfate pentahydrate (CuSO₄.5H₂O), copper(II) chloride (CuCl₂); nickel compounds such as nickel(II) chloride hexahydrate (NiCl₂.6H₂O), and nickel(I) nitrate hexahydrate (Ni(NO₃)₂.6H₂O); gold compounds such as tetrachloroauric(III) acid tetrahydrate (HAuCl₄.4H₂O); and silver compounds such as silver(I) nitrate (AgNO₃) and silver methanesulfonate (CH₃SO₃Ag).

If a water soluble metal compound is directly added to the reductant aqueous solution, the reaction first locally proceeds around the compound added and thus the particle size of the metal nanoparticles becomes non-uniform and the particle distribution may become wide. Thus, the water soluble metal compound is preferably dissolved in water to prepare a diluted aqueous solution containing a metal ion and the aqueous solution is preferably added to the reductant aqucous solution.

The upper limit of the average particle size of the precipitated metal nanoparticles is preferably 200 nm and more preferably 150 nm. The lower limit of the average particle size of the metal nanoparticles is preferably 1 nm and more preferably 10 nm. When the average particle size of the metal nanoparticles exceeds the above-described upper limit, voids in the resulting metal coating film formed become larger and sufficient electrical conductivity may not be obtained. When the average particle size of the metal nanoparticles is lower than the lower limit, the separation efficiency may be degraded in the metal nanoparticle separation step S2 or the metal nanoparticles may not easily be uniformly dispersed in a solvent in the metal nanoparticle dispersion preparation step S3.

### <Metal Nanoparticle Separation Step>

In the metal nanoparticle separation step S2, the metal nanoparticles precipitated in the reductant aqueous solution in the metal nanoparticle precipitation step S1 are separated.

Examples of the method for separating the metal nanoparticles include filtration and centrifugal separation. The separated metal nanoparticles may be prepared into powder through steps of washing, drying, disintegrating, etc., but are preferably used as they are dispersed in an aqueous solution without being formed into powder in order to prevent agglomeration.

### <Metal Nanoparticle Dispersion Preparation Step>

In the metal nanoparticle dispersion preparation step S3, the metal nanoparticles separated from the reductant aqueous solution in the metal nanoparticle separation step are dispersed in a solvent to prepare a metal nanoparticle dispersion.

### (Solvent)

A mixture of water and one or more high-polarity solvents is used as the solvent for the metal nanoparticle dispersion. In particular, a mixture of water and a high-polarity solvent miscible with water is preferably used. The solvent for such a metal nanoparticle dispersion can be prepared from the reductant aqueous solution after precipitation of the metal nanoparticles. That is, a reductant aqueous solution containing metal nanoparticles is preliminarily subjected to a treatment such as ultrafiltration, centrifugal separation, water washing, electrodialysis, or the like so as to remove impurities and then a high-polarity solvent is added thereto to obtain a solvent that contains a particular amount of metal nanoparticles.

The high-polarity solvent is preferably a volatile organic solvent that can be evaporated in a short period of time in the sintering step S5. When a volatile organic solvent is used as the high-polarity solvent, the high-polarity solvent is evaporated in a short time in the sintering step S5 and the viscosity of the metal nanoparticle dispersion applied to the surface of the substrate can be rapidly increased without causing movement of the metal nanoparticles.

Any of various organic solvents that evaporate at room temperature (5° C. or higher and 35° C. or lower) can be used as this volatile organic solvent. Among them, a volatile organic solvent that has a boiling point of, for example, 60° C. or higher and 140° C. or lower at atmospheric pressure is preferable and an aliphatic saturated alcohol that has high volatility and good miscibility with water and includes 1 to 5 carbon atoms is preferable. Examples of the aliphatic saturated alcohol including 1 to 5 carbon atoms include methyl alcohol, ethyl alcohol, n-propyl alcohol, isopropyl alcohol, n-butyl alcohol, isobutyl alcohol, sec-butyl alcohol, tert-butyl alcohol, n-amyl alcohol, and isoamyl alcohol, which can be used alone or in combination.

The lower limit of the volatile organic solvent content in the entire solvent is preferably 10% by mass and more preferably 15% by mass. The upper limit of the volatile organic solvent content in the entire solvent is preferably 80% by mass and more preferably 70% by mass. When the volatile organic solvent content in the entire solvent is below the lower limit, the viscosity of the metal nanoparticle dispersion may not be increased in a short period of time during the sintering step S5. When the volatile organic solvent content in the entire solvent is beyond the upper limit, the water content is relatively decreased and thus wettability of the metal nanoparticle dispersion to surfaces of various substrates, such as glass, ceramic, and plastic substrates, may become insufficient.

The lower limit of the total solvent content in the metal nanoparticle dispersion is preferably 100 parts by mass and more preferably 250 parts by mass per 100 parts by mass of metal nanoparticles. The upper limit of the total solvent content in the metal nanoparticle dispersion is preferably 3000 parts by mass and more preferably 1000 parts by mass per 100 parts by mass of the metal nanoparticles. When the total solvent content in the metal nanoparticle dispersion is below the lower limit, the viscosity of the metal nanoparticle dispersion is increased and the smooth application of the dispersion may become difficult in the application step S4. When the total solvent content in the metal nanoparticle dispersion is beyond the upper limit, the viscosity of the metal nanoparticle dispersion is decreased and a coating film of a sufficient thickness may not be formed in the application step S4.

### (Water Soluble Resin)

The water soluble resin functions as a binder that prevents movement of metal nanoparticles during drying and sintering of the coating film in the sintering step S5. Since the water soluble resin is gradually pyrolyzed, sintering of the metal nanoparticles proceeds slowly. Thus, cracking of the metal coating film is hindered.

The lower limit of the number-average molecular weight of the water soluble resin is preferably 1000 and more preferably 5000. The upper limit of the number-average molecular weight of the water soluble resin is preferably 1,000,000 and more preferably 500,000. When the number-average molecular weight of the water soluble resin is below the lower limit, the water soluble resin is pyrolyzed undesirably fast in the sintering step S5, movement of the metal nanoparticles cannot sufficiently be inhibited, and the metal coating film may crack. When the number-average molecular weight of the water soluble resin is beyond the upper limit, the water soluble resin is not completely pyrolyzed in the sintering step S5, the residue of the water soluble resin may remain in the metal coating film, and the electrical conductivity of the metal coating film may be degraded.

Examples of the water soluble resin include polyvinyl alcohol, polyethylene glycol, methylcellulose, polyethyleneimine, and polyvinylpyrrolidone. Among these, polyvinyl alcohol, polyethylene glycol, and polyethyleneimine capable of effectively suppressing volume change of the coating film and relatively easily pyrolyzable are preferably used alone or in combination. Since polyvinyl alcohol and polyethylene glycol have high polarity, they have excellent dispersibility in water. Polyethyleneimine is suitable as a coating material for metal nanoparticles and has high compatibility to the metal nanoparticles. Thus, the water soluble resin is particularly preferably a combination of polyethyleneimine and at least one selected from polyvinyl alcohol and polyethylene glycol.

The lower limit of the amount of the water soluble resin contained in the metal nanoparticle dispersion is preferably 0.1 parts by mass and more preferably 0.2 parts by mass per 100 parts by mass of the metal nanoparticles. The upper limit of the amount of the water soluble resin contained in the metal nanoparticle dispersion is preferably 10 parts by mass, more preferably 2 parts by mass, and yet more preferably 1 part by mass per 100 parts by mass of the metal nanoparticles. If the amount of the water soluble resin is below the lower limit, the water soluble resin does not sufficiently act as a binder and the resulting metal coating film may crack or shrink. When the amount of the water soluble resin contained is beyond the upper limit, the pyrolysis residue of the water soluble resin remains as impurities in the metal coating film and thus the electrical conductivity of the metal coating film may be degraded.

### <Application Step>

In the application step S4, the metal nanoparticle dispersion is applied to a surface of a substrate. A known method for applying the metal nanoparticle dispersion may be employed, examples of which include a spin coating method, a spray coating method, a bar coating method, a die coating method, a slit coating method, a roll coating method, and a dip coating method. Alternatively, the metal nanoparticle dispersion may be applied to only part of the substrate by screen printing, by using a dispenser, etc.

### <Sintering Step>

In the sintering step S5, the coating film of the metal nanoparticle dispersion formed in the application step S4 is heated to evaporate the solvent in the metal nanoparticle dispersion and then the metal nanoparticles held together by the water soluble resin functioning as a binder are sintered. During this process of sintering the metal nanoparticles, the water soluble resin holding the metal nanoparticles together are pyrolyzed and thus only the metal nanoparticles are sintered and a metal coating film free of any organic matter is formed.

The heating temperature in this sintering step depends on the material of the metal nanoparticles etc., and is, for example, 150° C. or higher and 500° C. or lower.

As described above, according to the method for producing a metal coating film illustrated in FIG. 1, a metal nanoparticle dispersion that is used to form a metal coating film by application and sintering and contains metal nanoparticles having an average particle size of 200 nm or less, a solvent for dispersing the metal nanoparticles, and furthermore a water soluble resin is obtained in the metal nanoparticle dispersion preparation step S3. A metal coating film is formed by applying this metal nanoparticle dispersion in the step S4 and sintering the applied metal nanoparticle dispersion in the step S5.

### [Advantages]

Since the metal nanoparticle dispersion according to an embodiment of the present invention contains the above-described amount of the water soluble resin, the water soluble resin moderates shrinkage of the coating film during drying (evaporation of the solvent) of the coating film of the metal nanoparticle dispersion and, in the subsequent step of sintering the metal nanoparticles, sintering proceeds slowly as the water soluble resin is gradually pyrolyzed. Thus, a metal coating film with less crack can be formed by using the metal nanoparticle dispersion of the embodiment of the present invention. As a result, a layer of another material, in particular, a metal plating layer, can be more easily formed on the metal coating film formed by using the metal nanoparticle dispersion.

### Other Embodiments

All of the embodiments disclosed herein are merely exemplary in every aspect and should not be considered as limiting. The scope of the present invention is not limited to the features of the embodiments described above but is defined by the claims only, and all modifications and alterations within the meaning and scope of the claims and equivalents thereof are intended to be included in the scope of the present invention.

The metal nanoparticles can be produced by any of various known methods, such as a high temperature treatment method known as an impregnation method, and a vapor phase method instead of the liquid phase reduction method. However, the liquid phase reduction method is preferred since metal nanoparticles that are small in size and have uniform particle shape and size are obtained.

The metal nanoparticle dispersion can be produced by removing impurities from the reductant aqueous solution after the metal nanoparticles had been precipitated by the liquid phase reduction method, concentrating the resulting aqueous solution to decrease the water content, and adding a high polarity solvent to the resulting concentrated solution as needed. When a solvent prepared by conditioning and concentrating the reductant aqueous solution after precipitation of the metal nanoparticles is used as the solvent, agglomeration of the metal nanoparticles can be inhibited. In addition to concentrating the reductant aqueous solution, metal nanoparticles may be further added if needed.

### Examples

The present invention will now be described by using Examples. The description of Examples does not limit the interpretation of the present invention.

Copper nanoparticles were formed by reducing a copper ion through the liquid phase reduction method of the embodiment described above and were separated. A metal nanoparticle dispersion was prepared by using the separated copper nanoparticles. The average particle size of the copper nanoparticles was 50 nm.

A mixture of 200 parts by mass of water and 50 parts by mass of ethanol (ethyl alcohol) relative to 100 parts by mass of the copper nanoparticles was used as the solvent of the metal nanoparticle dispersion. The copper nanoparticles were dispersed in this solvent to obtain a metal nanoparticle dispersion No. 1.

To the metal nanoparticle dispersion No. 1, a solution preliminarily prepared by dissolving 1 part by mass of polyvinyl alcohol relative to 100 parts by mass of the copper nanoparticles in 49 parts by mass of water relative to 100 parts by mass of the copper nanoparticles was added as the water soluble resin of the metal nanoparticle dispersion. As a result, a metal nanoparticle dispersion No. 2 was obtained.

Each of the metal nanoparticle dispersions obtained as such was applied to a polyimide film to an average thickness of 0.5 μm and the applied dispersions were sintered at 350° C. in a nitrogen atmosphere to form metal coating films on the polyimide films.

The surfaces of the metal coating films were observed with a scanning electron microscope. The observation found that whereas the metal coating film formed by using the metal nanoparticle dispersion No. 1 had many cracks with a length of 1 μm or more, the metal coating film formed by using the metal nanoparticle dispersion No. 2 had substantially no cracks with a length of 1 μm or more.

This result confirmed that adding a water soluble resin to a metal nanoparticle dispersion effectively inhibited formation of cracks in the metal coating film.

Each of the metal coating films was subjected to electroless copper plating to form a composite alloy coating film having an average total thickness of 1 μm. The peel strength of the composite alloy coating films was measured to evaluate adhesion strength of the metal coating film to the polyimide film. The peel strength was measured in accordance with JIS-C-6481 (1996).

The result showed that the adhesion strength of the metal coating film formed by using the metal nanoparticle dispersion No. 1 to the polyimide film was 150 gf/cm and the adhesion strength of the metal coating film formed by using the metal nanoparticle dispersion No. 2 to the polyimide film was 500 gf/cm.

This result confirmed that addition of a water soluble resin to a metal nanoparticle dispersion improved adhesion strength of the metal coating film to the substrate.

The following additional note is also disclosed.

### (Additional Note 1)

A metal nanoparticle dispersion comprising metal nanoparticles having an average particle size of 200 nm or less, a solvent used to disperse the metal nanoparticles, and a water soluble resin.

Since the metal nanoparticle dispersion contains the water soluble resin in addition to the metal nanoparticles and the solvent, the water soluble resin moderates shrinkage of a coating film of the metal nanoparticle dispersion during drying (evaporation of solvent) of the coating film. Since the water soluble resin is gradually pyrolyzed during sintering of the metal nanoparticles, sintering proceeds slowly. Thus, a metal coating film with less crack can be formed by using this metal nanoparticle dispersion.

### INDUSTRIAL APPLICABILITY

The present invention is widely applicable to formation of metal coating films and is suitable for production of electronic parts such as printed circuit boards in particular.

### REFERENCE SIGNS LIST

S1 metal nanoparticle generation step
S2 metal nanoparticle separation step
S3 metal nanoparticle preparation step
S4 application step
S5 sintering step

1: A metal nanoparticle dispersion for forming a metal coating film by application and sintering, the metal nanoparticle dispersion comprising metal nanoparticles having an average particle size of 200 nm or less and a solvent used to disperse the metal nanoparticles,
wherein the metal nanoparticle dispersion further comprises a water soluble resin.

2: The metal nanoparticle dispersion according to claim 1, wherein an amount of the water soluble resin contained is 0.1 parts by mass or more and 10 parts by mass or less per 100 parts by mass of the metal nanoparticles.

3: The metal nanoparticle dispersion according to claim 1, wherein the water soluble resin has a number-average molecular weight of 1,000 or more and 1,000,000 or less.

4: The metal nanoparticle dispersion according to claim 1, wherein the water soluble resin is any one or combination of polyvinyl alcohol, polyethylene glycol, and polyethyleneimine.

5: The metal nanoparticle dispersion according to claim 1, wherein the metal nanoparticles comprise copper.

6: A metal coating film formed by applying the metal nanoparticle dispersion according to claim 1 and sintering the applied metal nanoparticle dispersion.
